(19) United States
(12) Patent Application Publication
(10) Pub. No.: US 2010/0088894 A1
(43) Pub. Date: Apr. 15, 2010

(54) METHOD FOR PREPARING ABRASIVE WATERJET MIXING TUBES

(76) Inventors: Roger M. Stark, Traverse City, MI (US); Jeffrey G. Gardner, Willamsburg, MI (US); Michael J. O'Malley, Traverse City, MI (US)

Correspondence Address: KENNAMETAL INC.;Intellectual Property Department, P.O. BOX 231, 1600 TECHNOLOGY WAY, LATROBE, PA, 15650, US

(21) Appl. No.: 12/249,493

(22) Filed: Oct. 10, 2008

(51) Int. Cl. B24C 5/04; B21D 51/00; B23P 11/00

(52) U.S. Cl. 29/890.142; 29/890.143; 29/458; 29/463

(57) ABSTRACT

A method for making an AWJ mixing tube having a longitudinal bore coated with an abrasion-resistant material, such as diamond. Two blocks having mating longitudinal sides are fastened together prior to machining the longitudinal bore along the junction of their mating surfaces. The blocks are separated and the complementary portions of the longitudinal bore are coated with an abrasion-resistant material. The two blocks are then joined together with the complementary portions of the longitudinal bore aligned to form the longitudinal bore.

### FIELD OF THE INVENTION

The present invention relates to methods of preparing abrasive waterjet mixing tubes having bores coated with an abrasion resistant material.

### BACKGROUND OF THE INVENTION

Abrasive water jet (“AWJ”) machining utilizes a very narrow stream of high pressure water laden with abrasive particles to erosion cut through a workpiece. The AWJ process AWJ machining is used in nearly every industry, including the automobile, aerospace, computer, electronic, and glass industries, to create precision parts from a wide variety of materials such as plastics, metals, glass, composites, ceramics, and rock, including those materials which are otherwise difficult to machine or cut. The AWJ process machines with high precision, very little kerf, and produces a clean, smooth edge thereby reducing or eliminating the need for costly post-machining edge treatment operations. Because AWJ machining is a low temperature operation, it produces no heat affected zone in the machined part and can be used to machine or cut heat treated parts without disturbing their heat treatment-induced material properties. AWJ machining heads may be guided by hand, machine, or computer with the most precise machining and cutting being obtained by computer-control of the AWJ machining head motion.

In a typical AWJ system, an intensifier pump is used to pressurize filtered water to the range of about 2,000 to 100,000 psi (14 to 690 MPa). The high pressure water is fed into an AWJ machining head where it is forced to pass through a nozzle orifice diameter as small as a few thousands of an inch (a few hundredths of a millimeter) to generate a high-velocity water jet. In commercial applications, abrasive particles such as garnet, alumina, or olivine are introduced into the high-velocity water jet as it passes through a mixing chamber within the AWJ machining head. The abrasive particles and the high-velocity water jet mix as they travel together through the small diameter longitudinal bore of a mixing tube in the AWJ machining head to form upon exiting the mixing tube a narrow, abrasive, high-velocity water jet that is capable of making precise cuts through almost any kind of material.

An AWJ mixing tube longitudinal bore is subjected to severe jetting abrasion, or erosion, from the high-velocity water jet and the abrasive particles it may carry. However, the precision and the efficiency of AWJ machining is greatly affected by wear of the longitudinal bore of the mixing tube. Although the longitudinal bore diameters generally are on the order of 0.010 to 0.060 inches (0.25 to 1.5 mm) and the overall lengths of AWJ mixing tubes are usually on the order of 2 to 4 inches (5 to 10 cm), longitudinal bore diameter erosion of just a few thousands of an inch (a few hundredths of a millimeter) can greatly reduce the machining efficiency and degrade the machining precision, especially when the longitudinal bore erosion is near the exit end of the mixing tube. AWJ mixing tube longitudinal bore wear results in longer machining times, less precise machining, down time for replacing the worn mixing tube, and the cost of the replacement AWJ mixing tubes. To minimize this problem, AWJ mixing tubes are commonly made of very hard materials, such as cemented carbides and composite carbides.

There has been much effort in the art to harden the AWJ mixing tube against abrasive wear by depositing a hard coating on the surface of its longitudinal bore. However, because of the high length-to-diameter ratios of the longitudinal bores and the line-of-sight deposition path limitation of the various vapor deposition methods, e.g., chemical vapor deposition (“CVD”) and physical vapor deposition (“PVD”) and their variants, it has not been possible to directly coat the interior of the longitudinal bore with much success. Various approaches have been taken to circumvent this problem.

One approach is to make a free-standing longitudinal hollow core of a deposited abrasion-resistant material and then encase it in a more durable material. For example, U.S. Pat. No. 5,363,556 to Banholzer et al. describes a method of making a AWJ mixing tube by depositing a diamond layer by CVD on a funnel shaped support member to form a diamond inner member of the AWJ mixing tube, separating the inner member from the support member, depositing a material having a higher coefficient of thermal expansion than diamond on an outer side of the inner member to form an outer member of the AWJ mixing tube, and then cooling the AWJ mixing tube to contract the outer member in order to induce compressive stresses of sufficient strength on the inner member to substantially prevent the formation of cracks in the inner member. U.S. Pat. No. 5,439,492 to Anthony et al. (“the '492 patent”) describes making an AWJ mixing tube by depositing a layer of diamond by CVD on a solid mandrel followed by removing the mandrel mechanically or by chemical etching to form a free-standing core having the longitudinal bore of the AWJ mixing tube and then, optionally, providing a steel tube to support the diamond film. United States 5,869,133 to Anthony et al. improves upon the method of the '492 patent by using a hollow mandrel to reduce the time required for removing the mandrel by acid etching. Japan Laid-Open Publication Number Hei 3-126600 teaches creating a diamond tube by CVD deposition on the surface of a cylindrical substrate, dissolving away the substrate, then either (a) clamping the diamond tube between the split halves of an outer cylinder; (b) vapor-depositing a metal interface layer on the outside of the diamond tube and then soldering the metal-coated diamond tube to the split-tube halves of a hard-alloy outer cylinder; or (c) sintering a mixture of tungsten carbide-plus-cobalt powder an encasing hard metal outer support around the diamond tube. These approaches, however, are very complex, require handling of the brittle deposited films, and involve difficult matching of a brittle core to an outer support member to achieve a favorable tensile stress state at the working surface of the longitudinal bore.

Another prior art approach to the problem is to separately groove complementary longitudinal bore portions into two longitudinal halves of an AWJ mixing tube, deposit a hard coating on the open-faced longitudinal bore portion surfaces, and then unite the two halves to form an operable AWJ mixing tube. For example, U.S. Pat. No. 5,785,582 to Stefanick et al. describes making an AWJ mixing tube from two oblong pieces of a hard ceramic material by separately grinding the two pieces longitudinally to form two complimentary sides of the longitudinal bore, and then joining together the two pieces by shrink fitting a metal sheath around them to form an AWJ mixing tube. German Patent No. DE 196 40 920 C1 discloses dividing an AWJ mixing tube body along its length near its longitudinal axis, cutting separate channels into the parted longitudinal surfaces, applying a diamond-like material coating of amorphous carbon to the channels by a laser arc coating process, and then bonding the two halves back together again.

Although this groove-coat-join approach overcomes some of the problems of the deposited core-plus-support member approach described above, the inventors of the present invention have recognized an inherent drawback of the groove-coat-join approach that has been apparently overlooked until now. With inventive insight, the inventors of the present invention have recognized that a high level of precision and repeatability must be employed during the machining of the two separate halves of the longitudinal bore and subsequent operation of joining of them together in order to prevent mismatched alignment. Mismatched alignment of the longitudinal bore halves results in a misshaped AWJ cutting stream and can cause accelerated wear of the AWJ mixing tube. The need for precision and repeatability extends beyond the operation of forming mirror image halves of the longitudinal bore. It also requires precise matching of the outer shapes of the two halves of the AWJ mixing tube into which the longitudinal bore halves are formed. It also requires heightened precision in the fixturing and alignment of the AWJ mixing tube halves during the separate longitudinal bore machining processes. Furthermore, the high level of precision and repeatability adds cost to the manufacturing process.

### SUMMARY OF THE INVENTION

The present invention provides methods of manufacturing AWJ mixing tubes having abrasion-resistant material coated longitudinal bores while overcoming at least some of the aforementioned drawbacks of the prior art. In accordance with the present invention, methods are provided for making AWJ mixing tubes using two blocks, each block having a mating surface parallel to its longitudinal axis. These two blocks are fastened together along their respective mating surfaces. A longitudinal bore is then machined across a portion of the longitudinal junction formed by the two mating surfaces. This simultaneous machining of the complimentary parts of the longitudinal bore in each of the two mating surfaces obviates the misalignment problems inherent in the prior art groove-coat-join methods while eliminating the costs associated with requirements for high precision and repeatability of those prior art methods. After the longitudinal bore is machined, the two blocks are separated and an abrasion-resistant coating is applied to the complimentary portions of the longitudinal bore. The two blocks are then joined together to form at least an abrasion-resistant material coated part of an AWJ mixing tube longitudinal bore.

### BRIEF DESCRIPTION OF THE DRAWINGS

The criticality of the features and merits of the present invention will be better understood by reference to the attached drawing. It is to be understood, however, that the drawing is designed for the purpose of illustration only and not as a definition of the limits of the present invention.

FIG. 1 is a flow diagram of a method of making an AWJ mixing tube according to a preferred embodiment of the present invention.

### DESCRIPTION OF PREFERRED EMBODIMENTS

In this section, some preferred embodiments of the present invention are described in detail sufficient for one skilled in the art to practice the present invention. It is to be understood, however, that the fact that a limited number of preferred embodiments are described herein does not in any way limit the scope of the present invention as set forth in the appended claims.

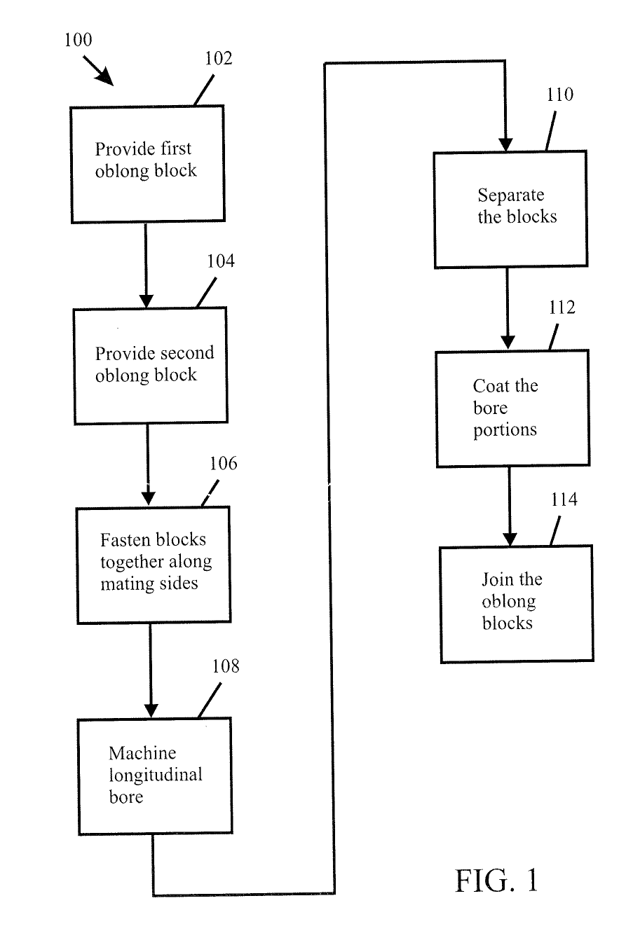

Referring to FIG. 1, there is shown a flow diagram for a method 100 of making an AWJ mixing block according to a preferred embodiment of the present invention. The method 100 comprises steps 102-114. In steps 102, 104, two blocks of a suitable material are provided. Each of the blocks has a mating surface running parallel to its longitudinal axis. Preferably, each of the blocks has a semi-cylindrical or semi-conical shape, and more preferably each of the blocks has a shape corresponding to one half of the AWJ mixing tube that is to be made. However, the blocks may have other shapes and further machining of the blocks, either separately or together, may be done at any time prior to the use of the AWJ mixing tube. In a preferred embodiment, each of the blocks is made from a rod having the length of the resultant AWJ mixing tube. Each of the rods is ground down longitudinally slightly off-center so that when the two blocks are fit together along their respective mating surfaces after coating, they form a perfectly round cylinder.

The block material may be any material or combination of materials known to those skilled in the art which is suitable for the application, e.g., cemented carbide, steel, and ceramic. Some preferred block materials are: boron carbide; tungsten carbide-cobalt with or without additives of nickel, molybdenum carbide, tantalum carbide, titanium carbide, niobium carbide, hafnium carbide, chromium carbide, and/or vanadium carbide, wherein the cobalt level is in the range of up to about 30 weight percent; kappa and/or alpha alumina; silicon-aluminum-oxynitrides; tool steels; and combinations there foregoing. Most preferably, the block material is a composite carbide comprising tungsten carbide and no more than 0.2 weight percent cobalt, such as those sold under the brand names ROCTEC® 100 and ROCTEC® 500 by Kennametal, Inc., Latrobe, Pa., U.S.

The mating surfaces are configured to complement one another so that they fit together at least along what is to be the length of the resultant AWJ mixing tube. Preferably, each of the mating surfaces is a mirror image of the other, and more preferably each mating surface is also planar. In some embodiments, the mating surfaces have features to allow the two blocks to interlock together along the junction of the mating surfaces. Also, in some embodiments, the mating surfaces have features, e.g., grooves or dimpling or roughening, to enhance the effectiveness of the use of an adhesive to join the blocks together in step 114. It is also within the contemplation of the present invention that the mating surfaces be configured so that when the blocks are fastened together, the longitudinal bore is partly or incompletely formed, thus reducing the amount of material that is to be removed from the blocks during the machining of the longitudinal bore in step 108.

In step 106, the two blocks are fastened together along their mating surfaces forming a longitudinal junction at the interface of the mating surfaces. Preferably the two blocks are clamped together, e.g., in a fixture designed to receive and hold together the particular block shapes, but any means of reversibly fastening two parts together for machining them in common may be used. For example, the blocks may be fastened together by a removable adhesive or tack welding or simply holding them against each other by way of a band or a sleeve.

In step 108, the longitudinal bore of the resultant AWJ mixing tube is machined along the longitudinal junction formed by the mating surfaces of the two blocks. Thus, complimentary parts of the longitudinal bore are machined into each of the mating surfaces of the two blocks. The method of machining used may be any machining method known to persons skilled in the art that is suitable for the block material and the desired shape of the longitudinal bore. For example, where the block material is a cemented carbide, e.g., transition metal cemented tungsten carbide, it is preferred that the machining be done by electric discharge machining (EDM) and more preferably by plunge EDM. Other examples of machining methods include mechanical drilling, electron-beam drilling, chemical drilling, and laser drilling. Combinations of machining methods may also be used, e.g., plunge EDM to rough cut the longitudinal bore followed by a mechanical drilling to finish cut the longitudinal bore followed by abrasive flow machining to polish the bore surface. Separate longitudinal portions of the longitudinal bore may be formed consecutively, e.g., a conical entryway may be machined and then the remaining cylindrical portion of the longitudinal bore may be machined. In a particularly preferred embodiment for making AWJ mixing tubes that are 4 inches (10.16 cm) long or longer, plunge EDM is first used to form the full length of the longitudinal bore, followed by wire EDM to clean up the longitudinal bore surface, followed by plunge EDM to form a conical entryway. For making shorter AWJ mixing tubes, preferably the same machining sequence is used except that the wire EDM machining step is omitted.

The shape of the longitudinal bore may be any that is suitable for an AWJ mixing tube, e.g., see the various shapes described in U.S. Pat. No. 6,752,685 B2 to Ulrich et al. Preferably, the longitudinal bore is generally cylindrical with a conical entryway portion at one end.

In step 110, the blocks are separated from one another so as to expose the longitudinal bore surfaces. The separation may be done by any convenient means known to those skilled in the art and the means chosen depends largely on the means used in step 106 to fasten the blocks together.

In step 112, the abrasion-resistant coating is coated onto the complementary portions of the longitudinal bore by any method known by persons skilled in the art. Examples of coating methods that may be used include: CVD (e.g., plasma CVD, microwave CVD, hot filament CVD); PVD; electron beam; and combinations of the foregoing.

The coating may be monolayer or multilayer. Where the coating is multilayer, the successive layers may be of the same or different materials and interface bonding layers may be used.

The coating may be any abrasion-resistant material that is applicable by a coating process or a combination of several such abrasion-resistant materials. Examples of some preferred abrasion-resistant materials include: diamond; diamond-like carbon; silicon carbide; aluminum oxide (kappa and/or alpha); boron carbide; transition metal carbides (e.g., titanium carbide); transition metal borides (e.g., titanium diboride); titanium-aluminum-oxycarbonitrides; titanium-carbonitrides; cubic boron nitride; alternating nanolayers of titanium-aluminum-nitride and titanium nitride; and combinations of the foregoing. The coating is preferably deposited across the entire mating surface, but may be applied to lesser areas. The surfaces to be coated may be cleaned or prepared as necessary for the coating process that is to be used.

In step 114, the two blocks are joined together with their complementary portions of the longitudinal bore aligned so as to form the complete longitudinal bore. The joining together may be by any suitable means known to persons skilled in the art. Preferably, the joining together is permanent, e.g., by adhesives, soldering, welding, brazing, diffusion bonding, interference- or shrink-fitting within a sleeve or bands, or a combination thereof. However, it is also within the contemplation of the present invention that the joining together be reversible, e.g., by releasable clamps, removable fasteners (either through or around the blocks), a removable sleeve, a removable adhesive, or any combination thereof. The joining together is preferably performed prior to the resultant AWJ mixing tube being placed in an AWJ machine, but it may also be done by placing the separate blocks within a fixture that is part of the AWJ machine. Regardless of whether the joining together is permanent or reversible, the joining together means provides the resultant AWJ mixing tube with the hoop strength necessary for the AWJ cutting operation in which it is to be used.

Optionally, the resultant AWJ mixing tube may be subjected to further machining operations after the joining together step 114 has been completed. For example, the outer surface of the resultant AWJ mixing tube may be machined to a desired length or shaped to accommodate placement of the AWJ mixing tube into a particular AWJ machine. The machining used depends on the material of the resultant AWJ tube that is to be machined and the objective of the machining. Care should be taken during any post-joining machining to avoid damaging any part of the AWJ mixing tube.

It is to be understood that the AWJ present invention also includes embodiments for making AWJ mixing tubes which are internally segmented along their lengths, e.g., the AWJ mixing tubes described in U.S. Pat. No. 6,851,627 to Hashish et al. In such embodiments, the method 100 described with reference to FIG. 1 applies as follows. In each of the steps 102-114, the first and second blocks are processed and joined together to form a segment of the resultant AWJ mixing tube. The method 100 may be used to make a single segment with the other segments being made by conventional means or it may be used to make all of the segments of the resultant AWJ mixing tube. In embodiments of the present invention wherein more than one segment is made by the method 100, the step 114 of joining together the two blocks of each segment may be done at the same time, e.g., inserting corresponding blocks for each segment into a common sleeve to make the AWJ mixing tube, or at different times.

While only a few embodiments of the present invention have been shown and described, it will be obvious to those skilled in the art that many changes and modifications may be made thereunto without departing from the spirit and scope of the present invention as described in the following claims. All patent applications and patents, both foreign and domestic, and all other publications referenced herein are incorporated herein in their entireties to the full extent permitted by law.

What is claimed is:

1. A method of making an abrasive waterjet mixing tube having a longitudinal bore from two blocks, the method comprising the steps of:
a) providing a first block having a longitudinal axis and a mating surface parallel to the longitudinal axis;
b) providing a second block having a longitudinal axis and a mating surface parallel to the longitudinal axis;
c) fastening together the first and second blocks along their respective mating surfaces to form a longitudinal junction;
d) machining at least part of the length of the longitudinal bore along the junction, the longitudinal bore comprising a first part along the mating surface of the first block and a second part along the mating surface of the second block;
e) separating apart the first and second blocks;
f) coating the first and second parts of the longitudinal bore with an abrasion-resistant material;
g) joining together the first and second blocks with the first and second parts of the longitudinal bore aligned to form at least part of the length of the longitudinal bore.

2. The method of claim 1, wherein the machining of step (d) is performed by at least one selected from the group consisting of plunge EDM drilling, EDM wire cutting, mechanical drilling, electron-beam drilling, chemical drilling, and laser drilling.

3. The method of claim 1, wherein the machining of step (d) is performed by using more than one machining method.

4. The method of claim 1, wherein the step of fastening together in step (c) is performed by clamping the first and second blocks together.

5. The method of claim 4, wherein the clamping is performed by fitting a sleeve around the first and second blocks.

6. The method of claim 1, wherein the step of fastening together in step (c) is performed by reversibly adhesively joining together the first and second blocks along their respective mating surfaces.

7. The method of claim 1, wherein at least one of the first and second blocks has a semi-cylindrical shape.

8. The method of claim 1, wherein at least one of the first and second blocks has a semi-conical shape.

9. The method of claim 1, further including the step of selecting at least one of the first and second blocks to be a material selected from the group consisting of cemented carbide, composite carbide, steel, ceramic, and combinations thereof.

10. The method of claim 9, wherein the group from which the material is selected consists of boron carbide; tungsten carbide-cobalt with or without additives of nickel, molybdenum carbide, tantalum carbide, titanium carbide, niobium carbide, hafnium carbide, chromium carbide, and/or vanadium carbide, wherein the cobalt level is in the range of up to about 30 weight percent; kappa and/or alpha alumina; silicon-aluminum-oxynitrides; tool steels; and combinations thereof.

11. The method of claim 1, wherein the step of coating in step (f) is performed by at least one selected from the group consisting of chemical vapor deposition, physical vapor deposition, electron beam deposition, and combinations thereof.

12. The method of claim 1, further comprising the step of selecting the abrasion-resistant-material in step (f) to be at least one selected from the group consisting of diamond; diamond-like carbon; silicon carbide; kappa aluminum oxide; alpha aluminum oxide; boron carbide; transition metal carbides; transition metal borides; titanium-aluminum-oxycarbonitrides; titanium-carbonitrides; cubic boron nitride; titanium-aluminum-nitride; titanium nitride; and combinations thereof.

13. The method of claim 1, wherein the step of joining together in step (g) is performed by clamping together the first and second blocks.

14. The method of claim 13, wherein the clamping is performed by fitting a sleeve around the first and second blocks.

15. The method of claim 1, wherein the step of joining together in step (g) is performed by adhesively joining together the first and second blocks along their respective mating surfaces.

16. The method of claim 1, further comprising the step of machining an outer surface of the first and second blocks after step (g) has been performed.

17. The method of claim 1, further comprising the step of selecting the longitudinal bore to include a funnel-shaped entryway portion.

18. The method of claim 1, further comprising the step of selecting the longitudinal bore to have a non-circular cross-sectional shape perpendicular to its axis along at least a portion of its length.

19. The method of claim 1, wherein the mating surfaces of the first and second blocks are planar.

20. The method of claim 1, wherein the AWJ mixing tube comprises multiple internal longitudinal segments, and steps (a) through (g) are performed to make at least one of the internal longitudinal segments.

21. The method of claim 20, wherein more than one internal longitudinal segment is made by performing steps (a) through (g), each internal longitudinal segment having a respective set of corresponding first and second blocks, and step (g) is performed at the same time for all of the respective sets of first and second blocks.
